(19) United States
(12) Patent Application Publication
(10) Pub. No.: US 2024/0089523 A1
(43) Pub. Date: Mar. 14, 2024

(54) SYSTEMS AND METHODS FOR MITIGATING MISDETECTION OF MULTI-HOUSEHOLD USAGE OF A SUBSCRIPTION SERVICE

(71) Applicant: Netflix, Inc., Los Gatos, CA (US)

(72) Inventors: Ethan Venitz, San Francisco, CA (US); Eric James Crabb, Hawthorne, CA (US); Geoffrey Mason House, Alameda, CA (US); AJ Venturella, Los Angeles, CA (US); Anthony DeVere Edwards, San Francisco, CA (US); Christopher Bradley Kirk, Gardena, CA (US); Praveen Ramachandra, Los Gatos, CA (US)

(21) Appl. No.: 18/465,481

(22) Filed: Sep. 12, 2023

Related U.S. Application Data
(60) Provisional application No. 63/375,516, filed on Sep. 13, 2022.

(51) Int. Cl. H04N 21/258; H04N 21/254; H04N 21/43

(52) U.S. Cl. CPC H04N 21/25875; H04N 21/254; H04N 21/25883; H04N 21/4307

(57) ABSTRACT

The disclosed computer-implemented methods and systems provide solutions for mitigating misdetection of display devices in connection with a subscription service. In some examples, the described methods and systems receive a content request from a display device, where the content request is correlated with a particular subscription service account. In some examples, the systems and methods further determine that the display device is not associated with the particular subscription service account. To verify the display device, the systems and methods utilize display timings and scan timings associated with a verification token to prove that the display device is validly located and can therefore be trusted in connection with the subscription service account. Various other methods, systems, and computer-readable media are also disclosed.

### CROSS-REFERENCE TO RELATED APPLICATION

This application claims the benefit of priority under 35 U.S.C. § 119(e) of U.S. Provisional Application No. 63/375,516, filed Sep. 13, 2022, the content of which are incorporated herein by reference in their entirety.

### BACKGROUND

Consumer electronics are more widely available and affordable now than they have ever been. In particular, display electronics (e.g., digital televisions) show exponential increases in display resolution, color rendering, and picture clarity. Because of this, users often add or replace such display electronics within their homes.

Frequent additions and upgrades to home electronics such as TVs, however, are often problematic in connection with various subscription services. To illustrate, subscription services that enable subscribers to stream digital media content to their electronic devices often attempt to validate a new device as being associated with a subscriber's streaming account. But, validating new devices is a tedious and frustrating process for users. To streamline this process, subscription services often attempt to automate validation by determining whether a new TV is using an Internet Protocol (IP) address associated with a subscriber's account. If so, subscription services will enable the TV to use the account. Unfortunately, using IP addresses for validation sometimes results in false-positive detection of multi-household usage of a subscriber's account.

Validation processes that rely on IP address comparisons fail when a subscription system does not have a complete or current record of IP addresses used by a household. For example, some households use two or three different IP addresses, but only one of those addresses is known to a subscription service as belonging to that household. In such situations, the subscription service sometimes incorrectly determines that a new TV belongs to a different household when a user attempts to connect the new TV to the subscription service via an IP address that is unknown to the subscription service. This type of false-positive multi-household usage detection is frustrating for users and costly for subscription services as processing and network resources are wasted in incorrectly detecting and notifying users regarding supposed multi-household usage.

### SUMMARY

As will be described in greater detail below, the present disclosure describes implementations in which misdetection multi-household usage of a subscription service account by a display device is mitigated by validating the location of the display device through the use of a validation token.

In one example, a computer-implemented method for mitigating misdetection of multi-household usage of a subscription service account includes detecting, at a subscription service server and from a display device, a content request correlated with a subscription service account. In response to determining that the display device is not associated with the subscription service account, the method includes verifying the display device by receiving scan timing associated with a verification token displayed by the display device, and determining that the scan timing relative to the display device displaying the verification token satisfies a predetermined threshold. The method also includes generating a content request response based on the display device being verified.

In some examples, the method further includes determining that the display device is not associated with the subscription service account by identifying an internet protocol address of the display device, identifying an internet protocol address of another device associated with the subscription service account, and determining that the internet protocol address of the display device fails to match the internet protocol address of the other device associated with the subscription service account.

In some examples, verifying the display device further includes generating the verification token for display on the display device, and causing the display device to display the verification token according to a known offset. Additionally, in some examples receiving scan timing associated with the verification token displayed by the display device includes receiving one or more scan timestamps from a mobile device associated with the subscription service account.

Moreover, in some examples, causing the display device to display the verification token according to the known offset includes synchronizing a time of the display device to a time server associated with the subscription service, and causing the display device to display the verification token at a display timing based on the known offset and the synchronized time. Additionally, in some examples, determining that the scan timing relative to the display device displaying the verification token satisfies the predetermined threshold includes determining that a difference between the display timing and the scan timing is within the predetermined threshold. In at least one example, generating the content request response based on the display device being verified includes generating a success message for display on the display device, and transmitting a subscription service account verification to the display device enabling the display device to display a subscription service menu.

Some examples described herein include a system with at least one processor and physical memory including computer-executable instructions that, when executed by the at least one processor, cause the at least one processor to perform acts. In at least one example, the computer-executable instructions, when executed by the at least one physical processor, cause the at least one processor to perform an act including determining that a content request correlated with a subscription service account comes from an unknown display device that is not associated with the subscription service account. The computer-executable instructions further cause the at least one physical processor to perform an act including verifying the unknown display device by generating an animated verification token for display on the unknown display device, receiving, from a mobile device associated with the subscription service account, scan timings associated with the animated verification token displayed by the unknown display device, and determining that the scan timings associated with the animated verification token relative to the unknown display device displaying the animated verification token satisfy a predetermined threshold. In some examples, the computer-executable instructions further cause the at least one physical processor to perform an act including, in response to verifying the unknown display device, generating a content request response for the unknown display device and the mobile device.

In one or more examples, the animated verification token includes a series of quick response codes, where each quick response code displays according to a known offset. Additionally, in some examples, receiving the scan timings associated with the animated verification token displayed by the unknown display device includes receiving a series of scan timestamps, wherein each scan timestamp corresponds to when a quick response code is displayed by the unknown display device as scanned by the mobile device associated with the subscription service account.

In one or more examples, the computer-executable instructions further cause the at least one physical processor to perform an act including determining that the mobile device is a trusted device by identifying a sub-network occupied by a known display device associated with the subscription service account, and determining that the mobile device is on the sub-network occupied by the known display device. Additionally, in some examples, the computer-executable instructions further cause the at least one physical processor to perform an act including determining that the mobile device is an untrusted device by identifying a sub-network occupied by a known display device associated with the subscription service account, and determining that the mobile device is not on the sub-network occupied the known display device.

In one or more examples, the computer-executable instructions further cause the at least one physical processor to perform acts including, prior to generating the content request response and in response to determining that the mobile device is an untrusted device, causing the known display device to display a second verification token, and receiving, from the mobile device, scan timings associated with the second verification token. In some examples, the second verification token matches the animated verification token.

In additional examples, the computer-executable instructions further cause the at least one physical processor to perform an act including verifying the unknown display device in response to determining that scan timings associated with the second verification token relative to the known display device displaying the second verification token satisfies the predetermined threshold. Moreover, in at least one example, generating the content request response includes generating a first success message for display on the unknown display device, generating a second success message for display on the mobile device, and transmitting a subscription service account verification to the display device enabling the unknown display device to display a subscription service menu.

In some examples, the above-described method is encoded as computer-readable instructions on a computer-readable medium. In one example, the computer-readable instructions, when executed by at least one processor of a computing device, cause the computing device to: detect, at a subscription service server and from a display device, a content request correlated with a subscription service account, in response to determining that the display device is not associated with the subscription service account, verifying the display device by receiving scan timing associated with a verification token displayed by the display device and determining that the scan timing relative to the display device displaying the verification token satisfies a predetermined threshold, and generate a content request response based on the display device being verified.

In some examples, the computer-readable medium further includes computer-executable instructions that, when executed by the at least one processor of the computing device, cause the computing device to generate the verification token comprising a series of quick response codes that display according to a known offset on the display device. In one or more examples, receiving the scan timing associated with the verification token includes receiving, from a mobile device, a series of scan timestamps wherein each timestamp reflects when a quick response code in the series of quick response codes was displayed by the display device as viewed by the mobile device. Additionally, in at least one example, determining that the scan timing relative to the display device displaying the verification token satisfies a predetermined threshold includes determining display timings for when the display device displayed each of the series of quick response codes according to the known offset, and determining whether differences between corresponding display timings and scan timestamps are within the predetermined threshold.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a diagram illustrating how a display device is misdetected by a subscription service as not being associated with a subscription service account in accordance with one or more implementations.

FIG. 2 is a schematic diagram of an environment in which a misdetection mitigation system operates in accordance with one or more implementations.

FIG. 3 is a sequence diagram of the misdetection mitigation system determining whether to verify an unknown display device in accordance with one or more implementations.

FIGS. 4A-40 are user interface diagrams on both the unknown display device and a mobile device illustrating a verification process implemented by the misdetection mitigation system in accordance with one or more implementations.

FIG. 5 is a sequence diagram of the misdetection mitigation system further verifying an untrusted mobile device in accordance with one or more implementations.

FIGS. 6A-6P are user interface diagrams on both a known display device and the mobile device illustrating additional steps in the verification process implemented by the misdetection mitigation system in accordance with one or more implementations.

FIG. 7 is a detailed diagram of the misdetection mitigation system in accordance with one or more implementations.

FIG. 8 is a flow diagram of steps taken by the misdetection mitigation system in verifying an unknown display device in connection with a particular subscription service account in accordance with one or more implementations.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As mentioned above, improperly detecting multi-household usage often results in end-user dissatisfaction and wasted subscription service resources. The following disclosure first highlights various challenges in dealing with such misdetection and then shows how using a verification process that relies on scan timing provides a more efficient and effective approach to validating display devices for subscription services.

Many options for preventing or addressing misdetection are burdensome, ineffective, or both. In one example that involves IP-based validation, a conventional validation system blocks a newly added TV within a particular household simply because a previously-validated TV used the household's old IP address. In this situation, the validation system asks the user to turn on the previously-validated TV to update the IP address associated with it. This process is inconvenient for end users and is not effective in situations where a household uses multiple IP addresses.

To address misdetection arising from a household's use of multiple IP addresses, a traditional validation system prompts the end user to switch the newly added TV to the same access point (e.g., a WiFi router) as a previously-validated TV. This often requires an end user to find the proper TV settings, identify the correct network for the switch, and enter a password using a TV remote. In other cases, conventional validation systems prompt the end user to connect both the previously-validated TV and the newly added TV to a mobile device's hotspot. Many users, however, do not have access to a mobile device hotspot. For those who do, the process of reconnecting multiple devices to a hotspot is often confusing and burdensome. In cases where an end user attempts to access a subscription service via a newly added TV that utilizes a Virtual Private Network (VPN), conventional validation systems may ask the end user to turn off the VPN, which is often technically challenging and leaves the network vulnerable.

As these examples demonstrate, addressing misdetection of multi-household usage of a subscription service is challenging, particularly when detection relies on IP address comparisons or uses VPNs. This suggests that an alternative to IP address-based detection is desirable. However, many available alternative validation processes are also problematic-often because such alternatives are easily bypassed or are unreliable. As an example, a validation system that shows an on-screen passcode (e.g., on a previously-validated TV) to be entered on a newly added TV is easily bypassed by the user taking a screenshot of the passcode and forwarding the screenshot to someone outside of their household. As another example, a validation system that validates a newly added TV based on comparing average network package travel time from a streaming server to a previously-validated TV against the same average network package travel time associated with the newly added TV is only effective in connection with devices that are hundreds or thousands of miles apart. More precise options that rely on network latency comparisons (e.g., asking a user to scan a sample stream and then comparing the latency of the scan to the latency of the stream) are typically computing resource-intensive and costly for subscription services to implement.

These examples show that because example subscription services are limited to determining TV locations based on IP addresses or other ineffective procedures, TVs are sometimes misidentified and blocked from receiving streamed media content even though these TVs are legitimately located. In contrast, the misdetection mitigation systems described herein are user-friendly, efficient, and effective at addressing misdetection. Furthermore, in some examples, the misdetection mitigation systems engage in validation processes that are independent of IP address concerns.

As described in greater detail below, a misdetection mitigation system uses timing gaps between displaying a QR code on a new or blocked TV and scanning the QR code with a mobile device to authenticate the legitimate location of the TV and validate it or unblock it. In one exemplary workflow, the misdetection mitigation system generates an animated QR code for display on a blocked TV. The misdetection mitigation system further enables a mobile device (e.g., a user's smartphone) to scan the animated QR code through the mobile device's camera and provide scan timestamps associated with the animated QR code. By comparing the display timing of the animated QR code on the blocked TV against the provided scan timestamps from the mobile device, the misdetection mitigation system determines that the blocked TV and the mobile device are in the same place. If the mobile device is using an IP address that is known to the subscription service, the misdetection mitigation system validates the blocked TV and then unblocks that TV from receiving streamed media content from the subscription service.

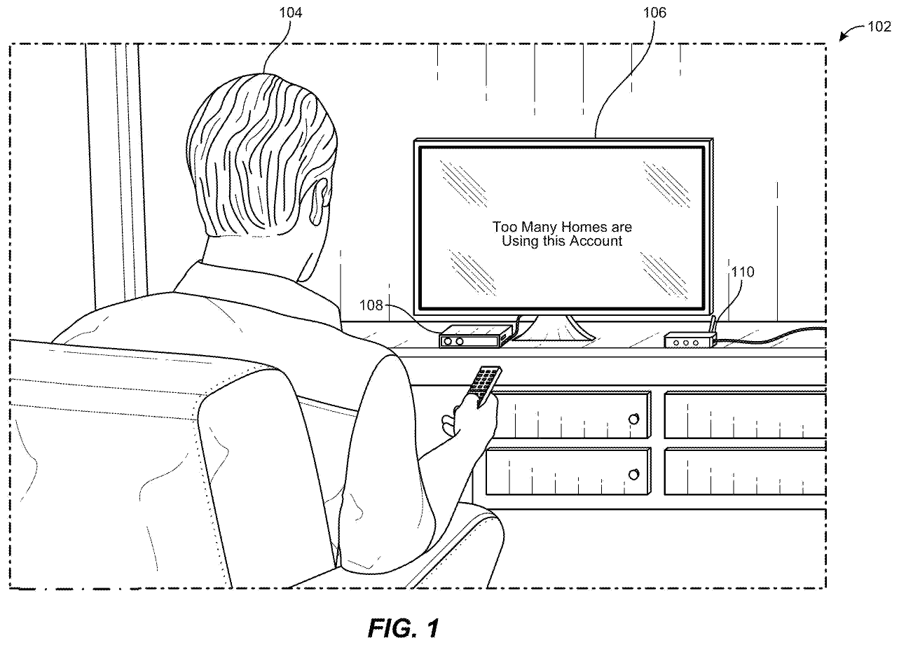

A typical use case of the misdetection mitigation system that arises in connection with IP-based validation processes is illustrated in FIG. 1. As shown in FIG. 1, example subscription services sometimes determine that a display device 106 (e.g., a TV) is not in the same location 102 (e.g., same house, same geofenced area) as other devices associated with a subscription service account corresponding to a particular subscriber 104. In some examples, the display device 106 is connected to an internet access point (e.g., such as a set top box 108 on an exclusive IP address), while other devices associated with the account of the subscriber 104 are connected to a different internet access point (e.g., a WiFi router 110 on a different IP address). Thus, the example subscription service incorrectly determines that the display device 106 is not in the same location 102 as the other devices associated with the subscriber 104, but rather is in a different location altogether (e.g., a separate house or geofenced area). In response to this determination, the example subscription service blocks the requested streamed content from the display device 106 following the incorrect determination that the subscription service account of the subscriber 104 is associated with multi-household use.

To correct this situation, the misdetection mitigation system provides a way to prove that a display device is in the same location as other devices associated with a subscription service account-even when the display device is on a different IP address than other devices at that location. As such, the misdetection mitigation system avoids the technological issues associated with example subscription services. For example, the misdetection mitigation system provides a flexible solution that enables multiple devices to be associated with a subscription service account, even when they are not on the same IP address. By avoiding such a reliance on IP addresses to determine co-location, the misdetection mitigation system improves the accuracy of example subscription services by accurately associating display devices with subscription service accounts.

Features from any of the implementations described herein may be used in combination with one another in accordance with the general principles described herein. These and other implementations, features, and advantages will be more fully understood upon reading the following detailed description in conjunction with the accompanying drawings and claims.

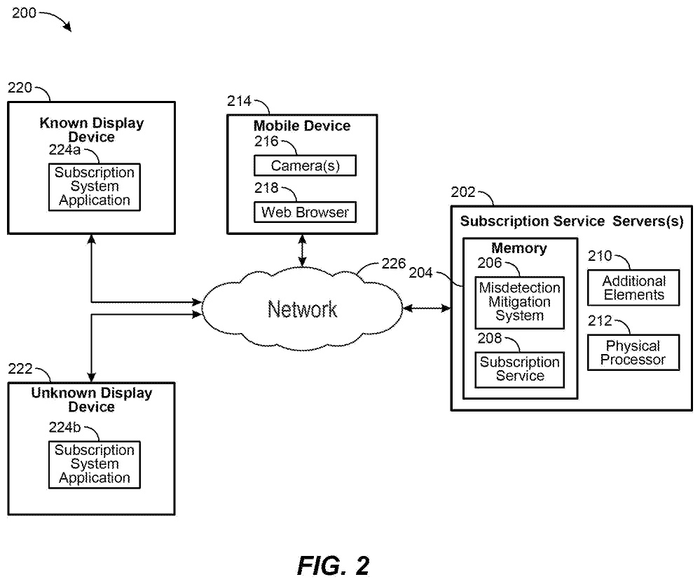

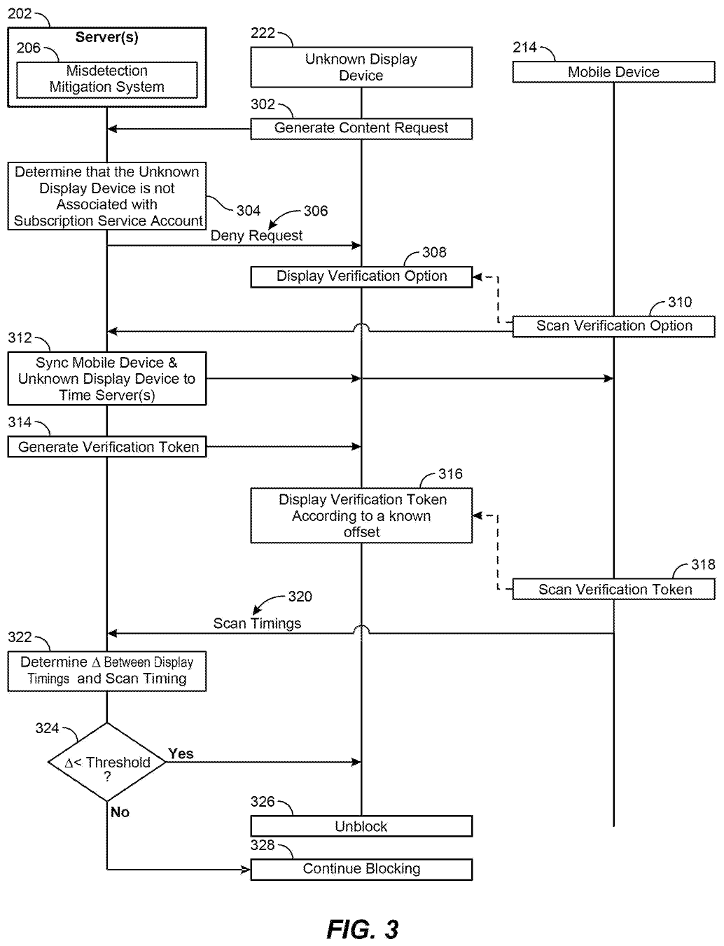

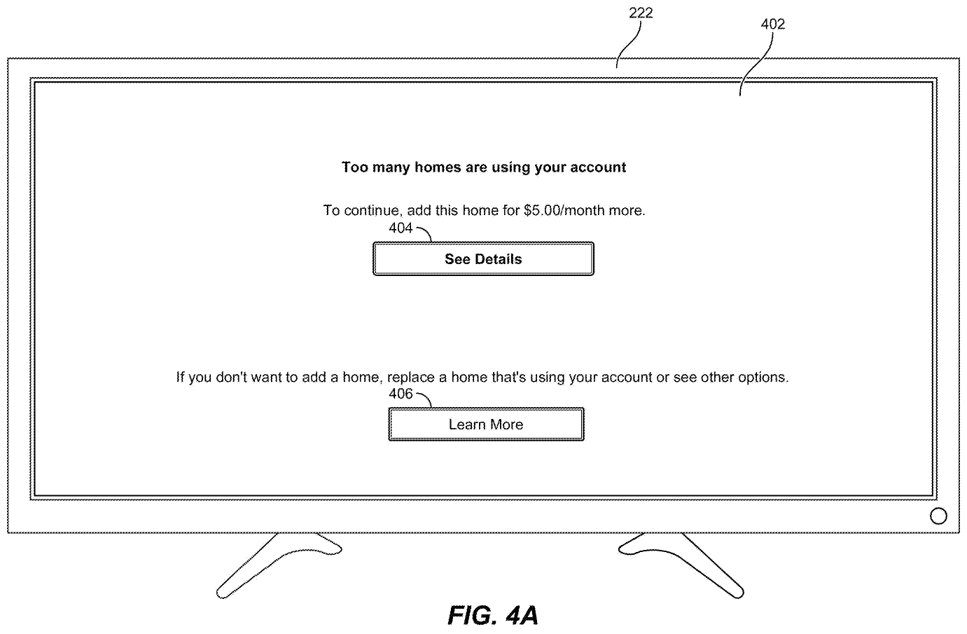

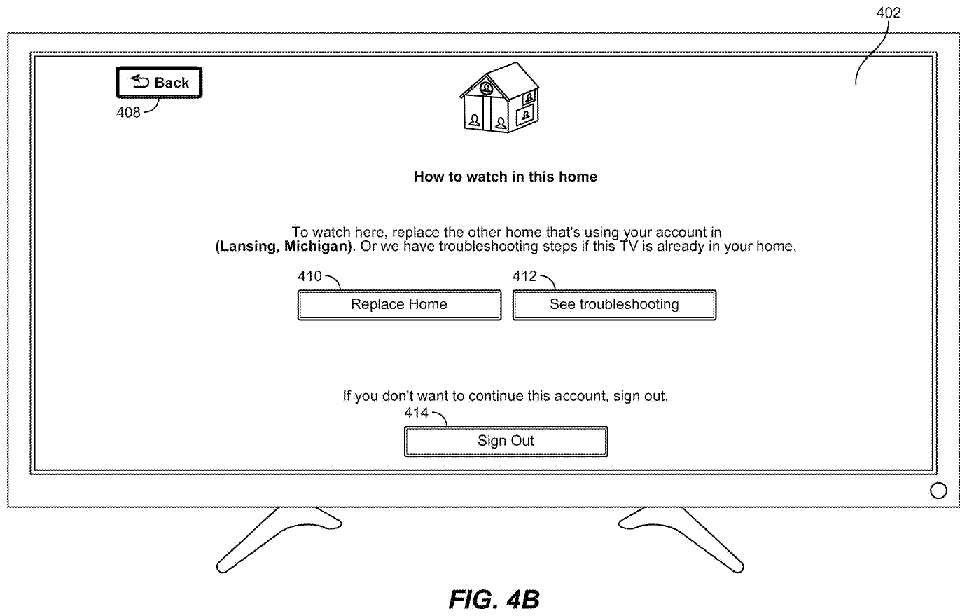

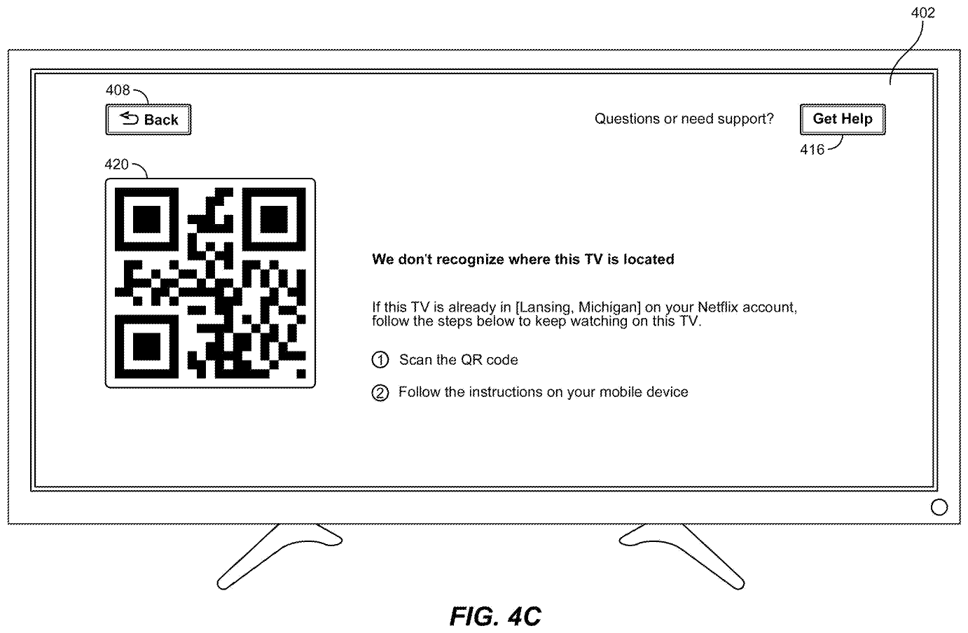

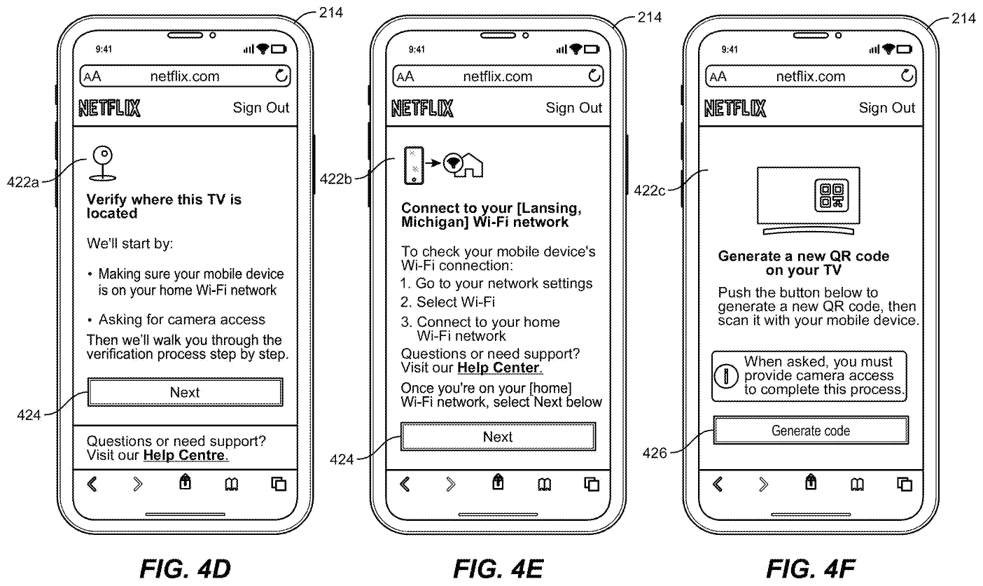

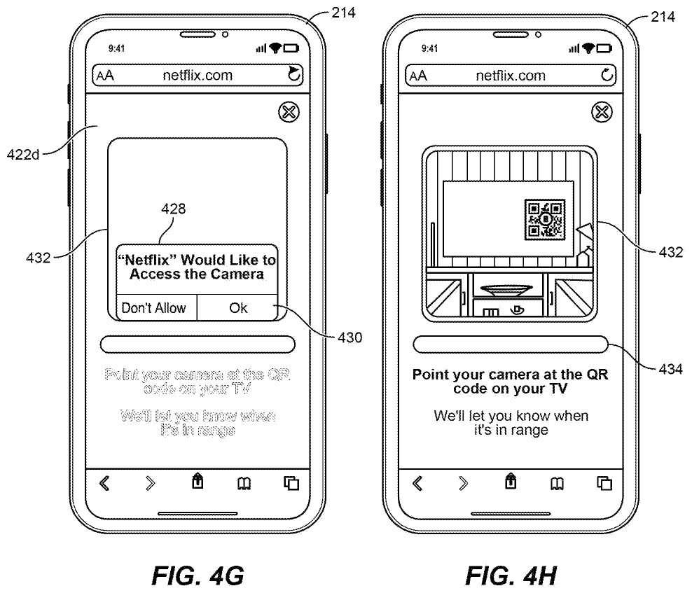

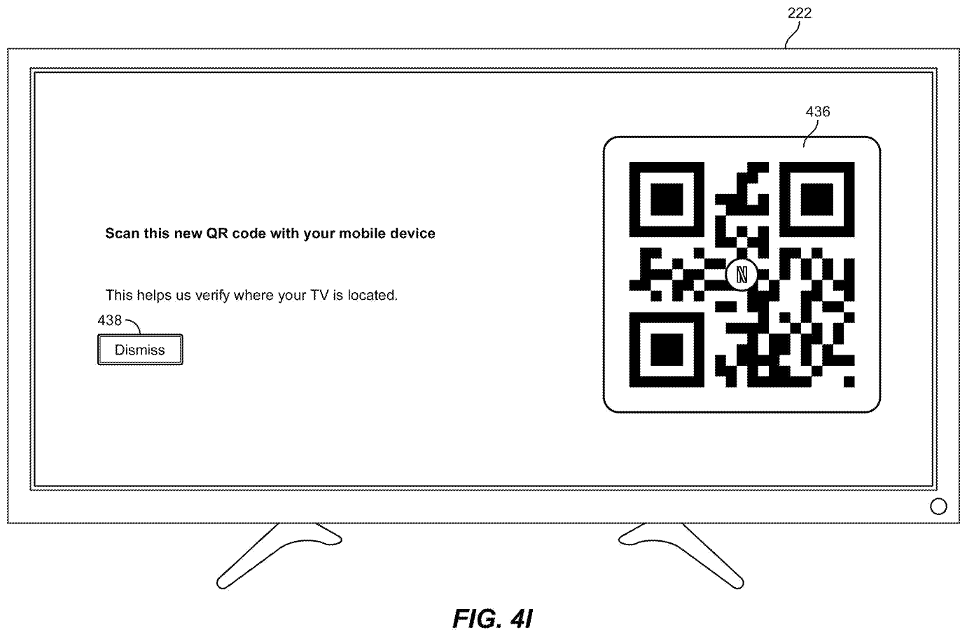

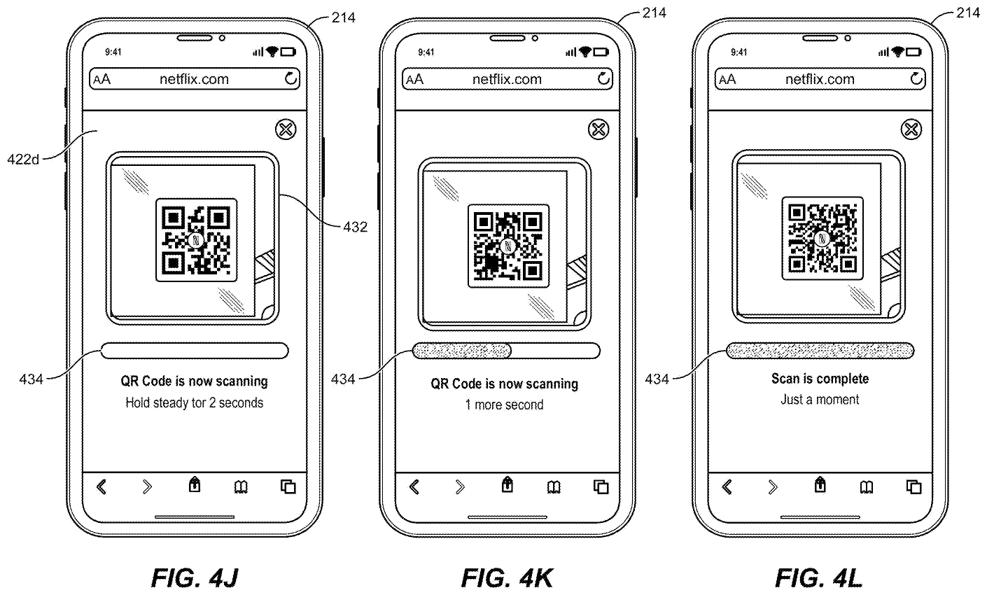

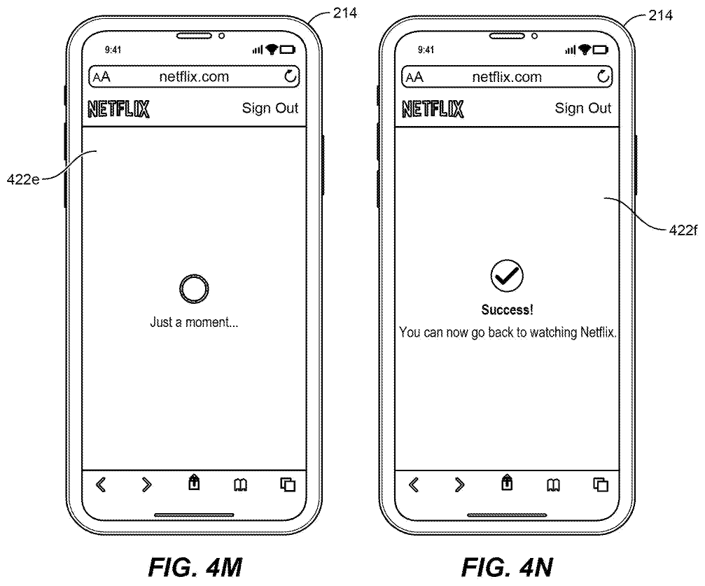

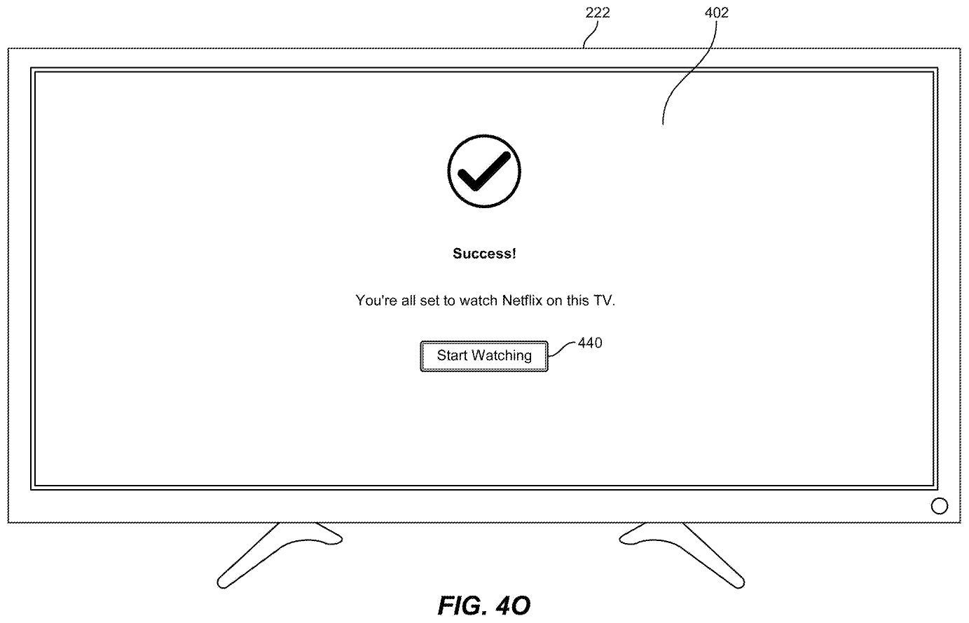

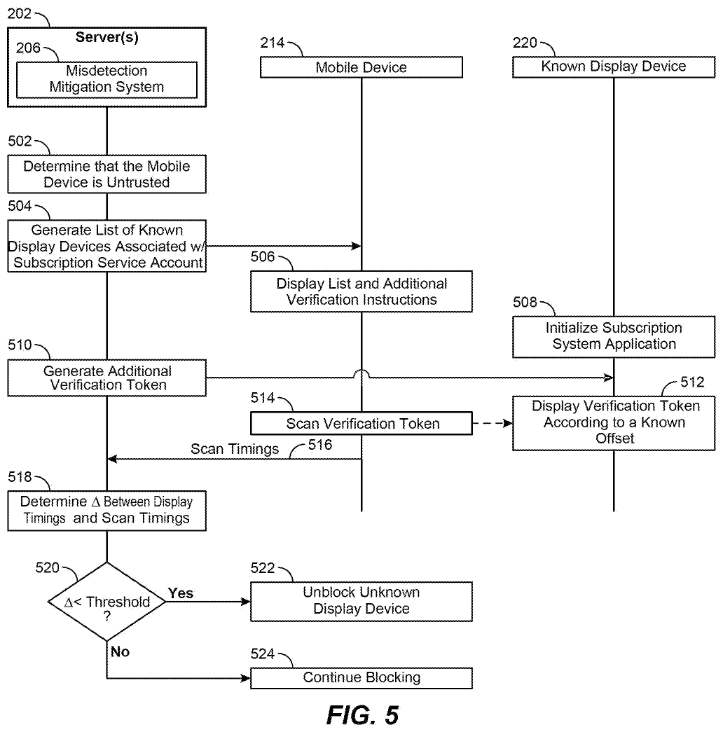

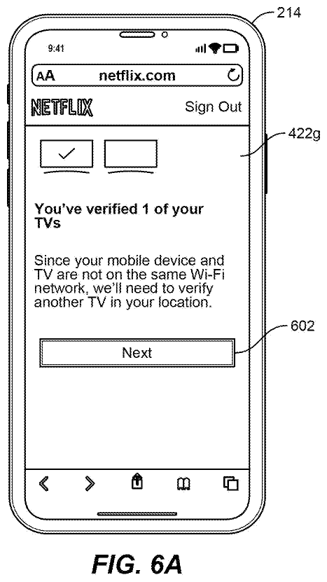

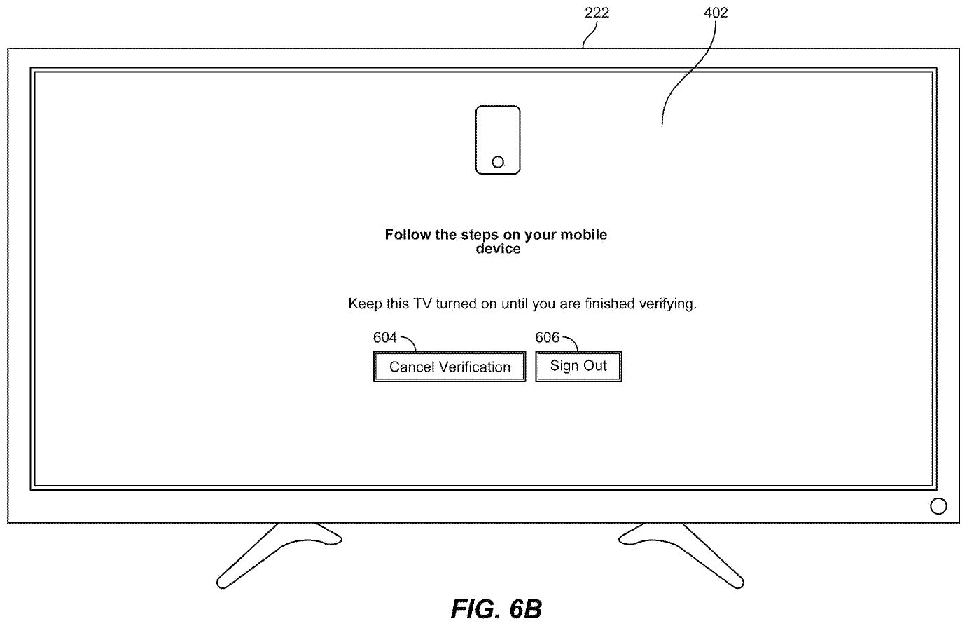

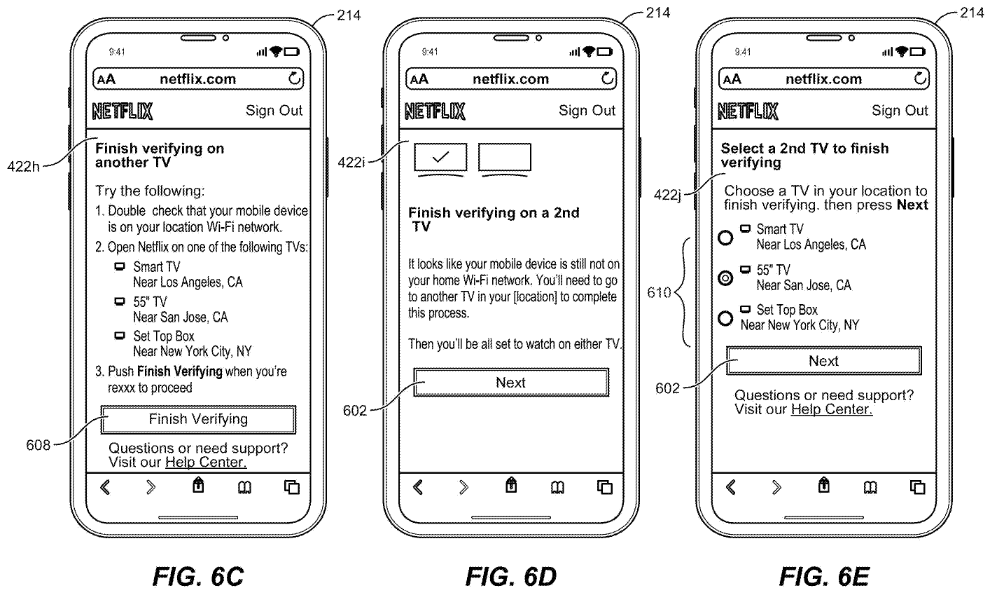

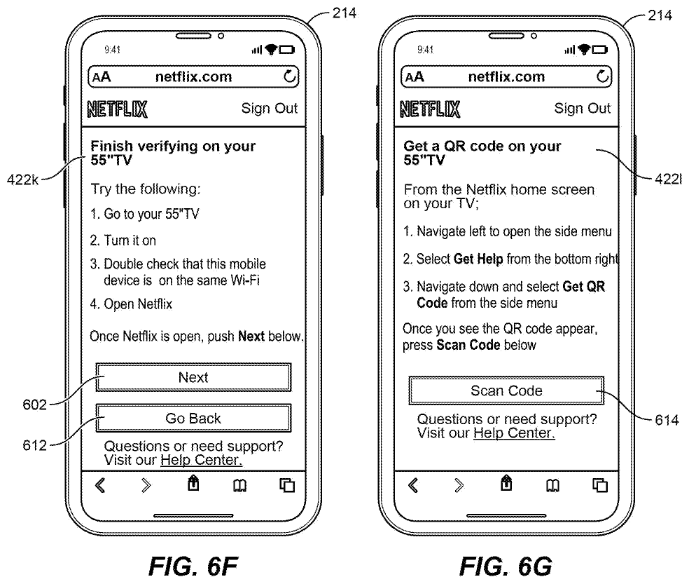

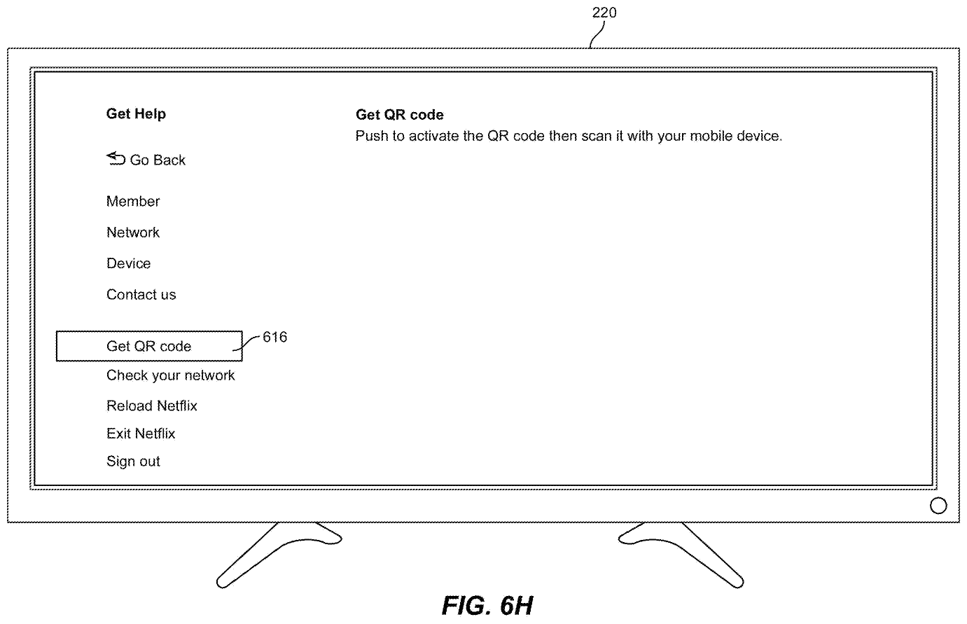

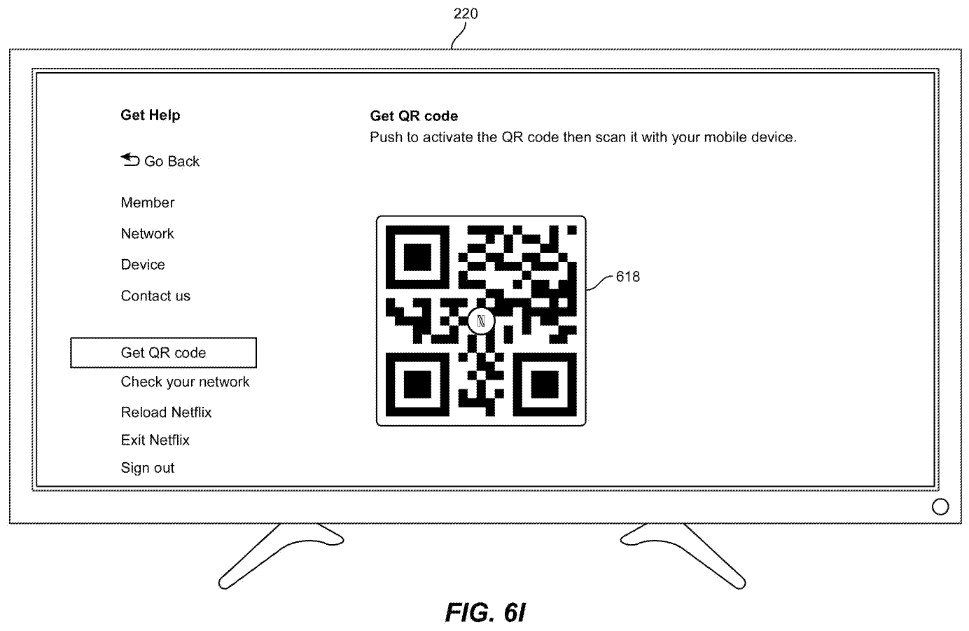

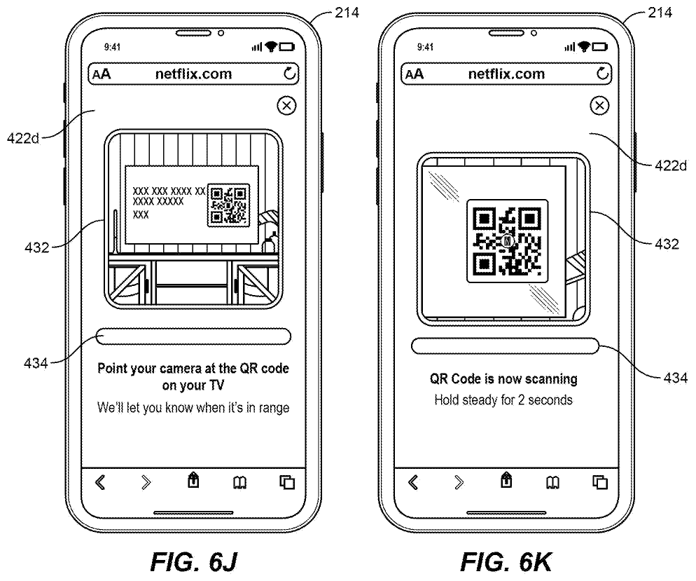

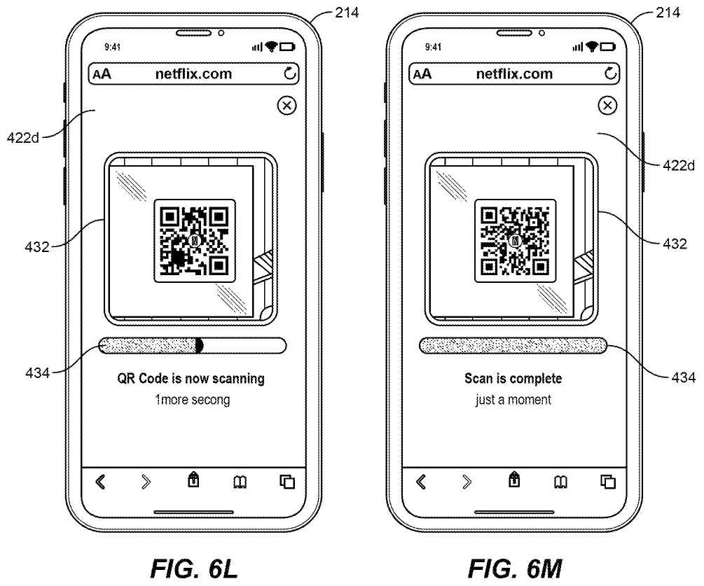

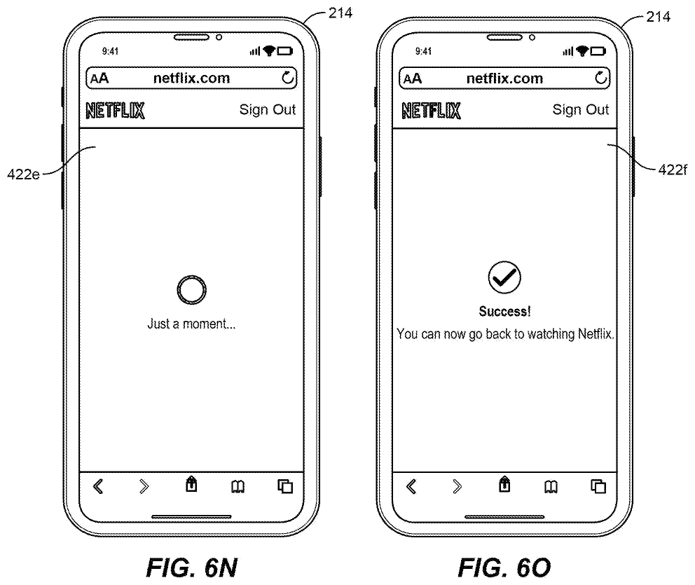

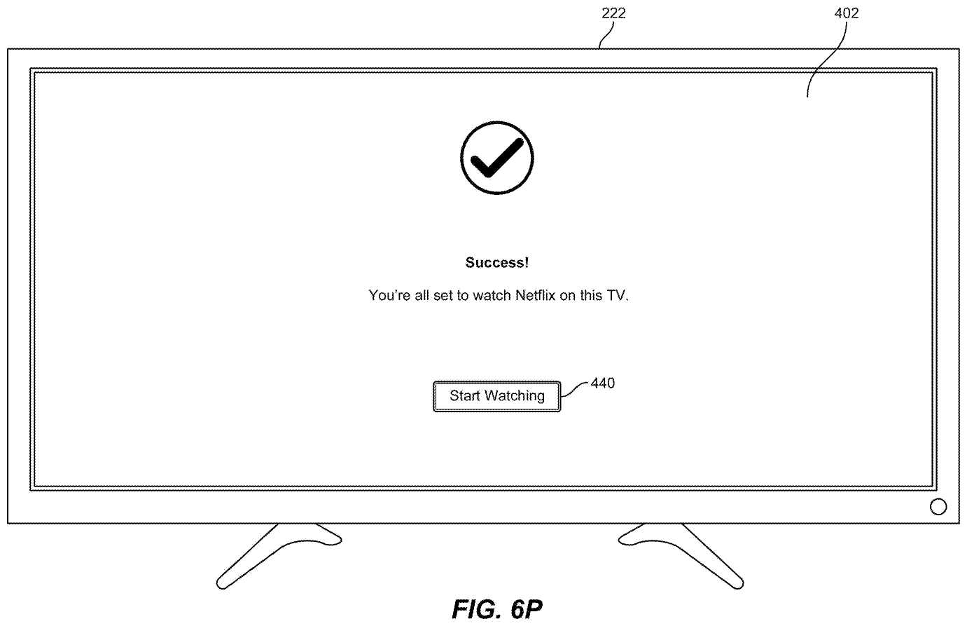

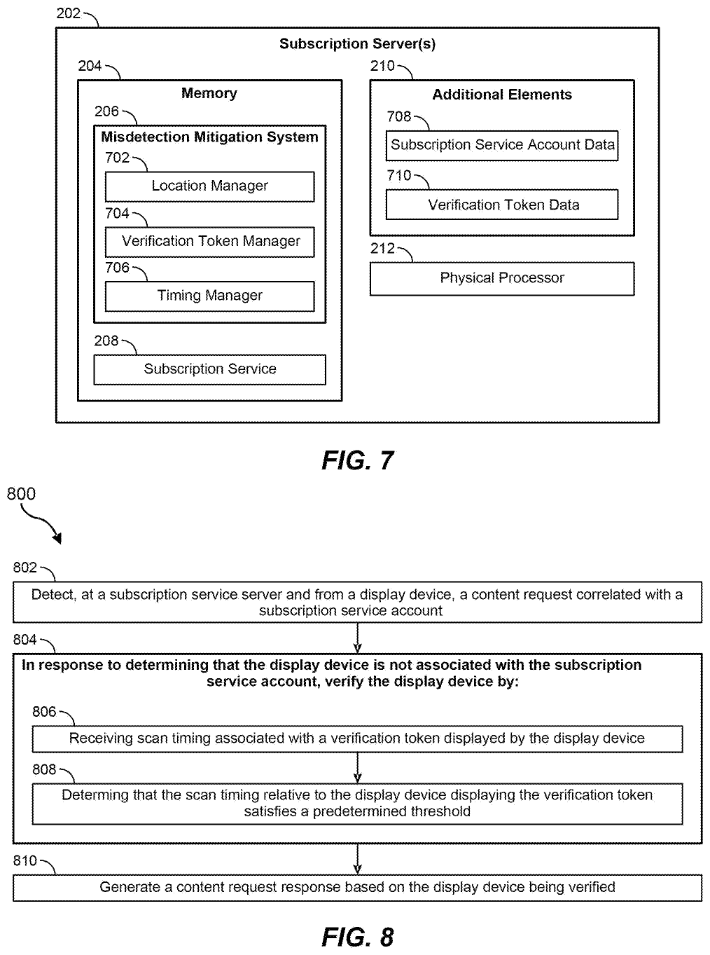

The following will provide, with reference to FIGS. 2-8, detailed descriptions of a misdetection mitigation system. For example, FIG. 2 is an overview diagram of an environment where the misdetection mitigation system operates in connection with a known display device, an unknown display device, and a mobile device. FIG. 3 illustrates a sequence diagram of the misdetection mitigation system interacting with the unknown display device and the mobile device to verify the location of the unknown display device, while FIGS. 4A-40 illustrate user interfaces displayed by the unknown display device and the mobile device during this verification process. FIG. 5 illustrates a sequence diagram of additional steps taken by the misdetection mitigation system when the mobile device is untrusted, while FIGS. 6A-6P illustrate additional user interfaces displayed by the known display device and the mobile device during these further verification steps. FIG. 7 illustrates additional details of the misdetection mitigation system, and FIG. 8 includes an overview flow diagram of the features provided by the misdetection mitigation system.

As mentioned above, FIG. 2 includes a diagram of an environment 200 implementing aspects of the present disclosure. For example, the network environment 200 includes a subscription service server(s) 202, a mobile device 214, a known display device 220, and an unknown display device 222. In one or more implementations, the mobile device 214, the known display device 220, and the unknown display device 222 are communicatively coupled to the subscription service server(s) 202 through a network 226. In many examples, the network 226 represents any type or form of communication network, such as the Internet, and may comprise one or more physical connections, such as a LAN, and/or wireless connections, such as a WAN.

In more detail, and in one or more implementations, the subscription service server(s) 202 include a memory 204, additional elements 210, and a physical processor 212. In at least one implementation, the memory 204 is installed with a misdetection mitigation system 206 and a subscription service 208. In some implementations, the additional elements 210 include media content repositories, subscription service account information, and so forth.

In one or more implementations, as shown in FIG. 2, the subscription service server(s) 202 includes one or more physical processors, such as the physical processor 212. The physical processor 212 generally represents any type or form of hardware-implemented processing unit capable of interpreting and/or executing computer-readable instructions. In one embodiment, the physical processor 212 accesses and/or modifies one or more components of the misdetection mitigation system 206. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, the memory 204 generally represents any type or form of volatile or non-volatile storage device or medium capable of storing data and/or computer-readable instructions. In one example, the memory 204 stores, loads, and/or maintains one or more of the components of the misdetection mitigation system 206 and/or the subscription service 208. Examples of the memory 204 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

In one or more implementations, the subscription service 208 within the memory 204 includes a networked digital media system that provides or streams digital content to subscribers. For example, in one implementation, the subscription service 208 streams digital content (e.g., digital movies, digital TV episodes, digital video games) over the network 226 to one or more of the known display device 220 and the unknown display device 222. As further shown in FIG. 2, the known display device 220 and the unknown display device 222 include a subscription system application 224a, 224b, respectively. Accordingly, in one or more implementations, users of the known display device 220 and/or the unknown display device 222 interact with the subscription service 208 via the subscription system applications 224a, 224b.

In one or more implementations, the known display device 220 and the unknown display device 222 are any type of display device. For example, in some implementations, one or more of the known display device 220 and the unknown display device 222 are televisions that access the subscription system applications 224a, 224b via a set top box. In additional implementations, the known display device 220 and/or the unknown display device 222 are “smart” televisions with the capability to stream content off of the internet via one or more applications (e.g., the subscription system application 224a or the subscription system application 224b). In other implementations, one or more of the known display device 220 and the unknown display device 222 are other types of display devices such as mobile devices (e.g., smart phones), tablets, laptops, smart wearables, etc.

In one or more implementations, the known display device 220 is “known” because it is a seed device associated with a subscriber's subscription service account within the subscription service 208. In at least one implementation, the known display device 220 becomes a seed device by being the first display device that the subscriber uses in connection with their subscription service account. It follows that the unknown display device 222 is “unknown” because it has not previously been associated with the subscriber's subscription service account. In some implementations, the unknown display device 222 is in the same physical location as the known display device 220 (e.g., within a predetermined geofence including the known display device 220). In other implementations, the unknown display device 222 is not in the same physical location as the known display device 220. In these other implementations, a bad actor may be attempting to game the subscription service 208 by piggy-backing on a legitimate subscriber's subscription service account from a location not associated with the legitimate subscriber.

In one or more implementations, the mobile device 214 is a mobile computing device such as, but not limited to, a smart phone, a tablet, and/or a smart wearable. In at least one implementation, the mobile device 214 includes a camera 216 and a web browser 218. For example, the camera 216 is front facing and/or rear facing. Additionally, the web browser 218 includes the ability to access and display internet information such as websites and webpages.

While FIG. 2, shows the misdetection mitigation system 206 operating on the subscription service server(s) 202 along with the subscription service 208, other arrangements are possible. For example, in additional implementations, the misdetection mitigation system 206 resides on a separate server from the subscription service 208. In that implementation, the misdetection mitigation system 206 receives data either from the subscription service 208 or directly from the mobile device 214, the known display device 220, and/or the unknown display device 222 across the network 226. Additionally, although the environment 200 illustrated in FIG. 2 includes a given number of devices and servers connected by the network 226, other implementations include any number of computing devices and servers in any arrangement.

In one or more implementations, the methods and steps performed by the misdetection mitigation system 206 reference multiple terms. For example, in some implementations the term “content request” refers to a request for a subscription service to transmit digital content. In one or more implementations, a content request includes, but is not limited, a request for one or more subscription service displays or menus to be transmitted to a display device, a request for a digital move to be streamed to the display device, a request for a digital TV episode to be streamed to the display device, and/or a request for a digital video game to be streamed to the display device. In one or more implementations, a “content request response” refers to a digital response that either provides the requested content or denies the request. In some implementations, a content request response includes one or more displays, messages for display, and/or a subscription service account verification that authorizes the display device to receive content from the subscription service.

In one or more implementations, a “subscription service account” refers to an account within the subscription service that is associated with a particular subscriber. In at least one implementation, a subscription service account includes one or more subscriber identifiers (e.g., an email address, a phone number, a username), login information, identifiers associated with one or more seed display devices or known display devices, IP addresses associated with the one or more seed display devices or known display devices, one or more locations (e.g., addresses, geofenced areas) associated with the subscriber, and so forth.

In one or more implementations, the term “scan timing” refers to when a camera of a mobile device views a verification token. For example, in one implementation, a scan timing includes a scan timestamp noted by the mobile device indicating when the camera of the mobile device viewed at least one image of a verification token. Additionally, the term “display timing” refers to when a display device displays a verification token. In at least one implementation, a display timing is based on a synchronized transmission time of when the display device received the verification token in connection with a known offset. For example, in one or more implementations, a known offset is an amount of time during which an image of a verification token is displayed by a display device.

In one or more implementations, a “sub-network” refers to an internet connection point. For example, in at least one implementation, a sub-network is associated with a single IP address provided via an internet connection such as a WiFi router, a set top box, and so forth.

As mentioned above, the misdetection mitigation system 206 provides ways to prove that an unknown display device (e.g., such as the unknown display device 222) is in a known location associated with a specific subscription service account. In one or more implementations, the misdetection mitigation system 206 utilizes the mobile device 214 in connection with the unknown display device 222 to verify the unknown display device 222. For example, FIG. 3 illustrates a sequence diagram of steps taken by the misdetection mitigation system 206 in verifying that the unknown display device 222 is in the same location as other devices associated with a specific subscription service account.

For example, in one or more implementations, at step 302 the unknown display device 222 generates a content request that is correlated with a subscription service account. In one example, the content request is a request for the subscription service 208 to stream digital content to the unknown display device 222 under the subscription service account. In at least one implementation, the misdetection mitigation system 206 detects the content request correlated with the subscription service account received from the unknown display device 222.

Then, at step 304 the misdetection mitigation system 206 determines that the unknown display device 222 is not associated with the subscription service account indicated by the content request. For example, in one or more implementations, the misdetection mitigation system 206 determines that the unknown display device 222 is not associated with the subscription service account by identifying an internet protocol address (e.g., an IP address) associated with one or more devices currently associated with one or more display devices indicated by the subscription service account. To illustrate, in one or more examples, the subscriber associated with the indicated subscription service account has previously watched content streamed from the subscription service 208 on a particular display device (e.g., the known display device 220). In response to the subscriber watching streamed content on the known display device 220, the subscription service 208 notes an IP address associated with the known display device 220 within the subscriber's subscription service account. As such, the misdetection mitigation system 206 determines that the unknown display device 222 is not associated with the subscriber's account by comparing an IP address of the unknown display device 222 against the IP address noted in the subscriber's subscription service account. If the two IP addresses do not match, the misdetection mitigation system 206 determines that the unknown display device 222 is not associated with the subscriber's subscription service account.

In response to this determination, at step 306 the misdetection mitigation system 206 denies the content request. In one or more implementations, this denial causes the subscription system application 224b on the unknown display device 222 to display a verification option at step 308. In at least one implementation, the verification option includes instructions for the user of the unknown display device 222 to utilizes a mobile device (e.g., the mobile device 214) to scan a code to begin a verification process that will enable the unknown display device 222 to be associated with the subscription service account. Accordingly, at step 310, the mobile device 214 scans the verification option, thereby triggering the misdetection mitigation system 206 to begin the verification process in connection with the unknown display device 222.

In one or more implementations, the misdetection mitigation system 206 leverages specific timing gaps to prove that the unknown display device 222 is positioned in a known location associated with a subscription service account. As such, in at least one implementation, at step 312 the misdetection mitigation system 206 synchronizes the unknown display device 222 and the mobile device 214 to a central time server to ensure that the internal clocks of both devices are accurate to a shared time source.

Following this synchronization, at step 314 the misdetection mitigation system 206 generates a verification token. In one or more implementations, the misdetection mitigation system 206 generates the verification token in many ways. For example, in one implementation, the misdetection mitigation system 206 generates the verification token as a single unique image. In certain implementations, the misdetection mitigation system 206 generates the single unique image such that it is encoded with various information.

In a preferred implementation, the misdetection mitigation system 206 generates the verification token as a series of images (e.g., QR codes) where each image is displayed within the series for a specified amount of time. To illustrate, in the preferred implementation, the misdetection mitigation system 206 generates the verification token including a series of eight QR codes that animate after a known offset. In one example, the misdetection mitigation system 206 generates the verification token including eight QR codes and an offset that instructs the unknown display device 222 on how long to display each of the eight QR codes. In additional implementations, the misdetection mitigation system 206 generates the verification token including any number of images such as, but not limited to, QR codes, image frames from one or more TV shows or movies available for streaming via the subscription service 208, image frames from one or more TV shows or movies watched under the subscriber's subscription service account, image frames from one or more TV shows or movies recommended for the subscriber by the subscription service 208, and so forth.

The misdetection mitigation system 206 transmits the generated verification token to the unknown display device 222 such that, at step 316 the unknown display device 222 displays the verification token according to the known offset. For example, in a preferred implementation, the unknown display device 222 (e.g., via the subscription system application 224b) displays the verification token via the subscription system application 224b such that each QR code in the series displays in sequence according to the known offset. To illustrate, if the known offset is 500 milliseconds, the unknown display device 222 will display the first QR code in the series for 500 milliseconds, then display the second QR code for 500 milliseconds, then display the third QR code for 500 milliseconds, and so forth. As such, the misdetection mitigation system 206 can expect the QR codes to have been displayed at display timings including: a timestamp to corresponding to the transmission time of the verification token being transmitted to the unknown display device 222, followed by timestamp t₁=t₀+500 milliseconds, timestamp t₂=t₁+500 milliseconds, and so forth.

In additional implementations, the misdetection mitigation system 206 displays the verification token (e.g., via the subscription system application 224b on the unknown display device 222) according to the known offset in other ways. For example, in one implementation, the verification token includes a single image or QR code that displays for the known offset. In that implementation, the misdetection mitigation system 206 can expect the single image to begin display at a display timing including timestamp to corresponding to the transmission time of the verification token being transmitted to the unknown display device 222, and end display at a display timing including t₁=t₀+the known offset. In yet another implementation, the known offset may be different for each image in a sequence of images within the verification token. In that implementation, the misdetection mitigation system 206 can expect each image to display according to the known offset that is specific to that image. In one or more implementations, the subscription system application 224b on the unknown display device 222 displays the verification token (e.g., including any number of images) to display in a loop for a given amount of time (e.g., two minutes).

In one or more implementations, the unknown display device 222 displays the verification token along with instructions for the user of the mobile device 214 to scan the verification token with the mobile device 214. Accordingly, at step 318 the mobile device 214 scans the verification token. For example, in at least one implementation, the mobile device 214 scans the verification token by noting scan timings (e.g., scan timestamps) associated with when each of the one or more images within the verification token is viewed by the camera 216 of the mobile device 214. To illustrate, in an implementation with a verification token including a series of eight QR codes, the mobile device 214 scans the verification token by generating a list of scan timings where each scan timing is a scan timestamp corresponding to when the camera 216 of the mobile device 214 viewed or perceived a particular QR code in the series. In a different implementation where the verification token includes a single image, the mobile device 214 scans the verification token by generating a list of two scan timings where the first scan timing is a scan timestamp corresponding to when the camera 216 of the mobile device 214 began viewing or perceiving the image, and the second scan timing is a timestamp corresponding to when the camera 216 of the mobile device 214 stopped viewing or perceiving the image.

In one or more implementations, at step 320 the mobile device 214 transmits the generated scan timings to the misdetection mitigation system 206 at the server(s) 202. In at least one implementation, the misdetection mitigation system 206 next determines that the scan timing relative to the unknown display device 222 displaying the verification token satisfies a predetermined threshold. For example, at step 322 the misdetection mitigation system 206 determines a difference between the display timings and the scan timings. To illustrate, as mentioned above, the misdetection mitigation system 206 determines display timings based on when the verification token is transmitted to the unknown display device 222 and the known offset. Thus, if the verification token includes three images, the misdetection mitigation system 206 determines three display timings including t₀=time of transmission, t₁=t₀+known offset, t₂=t₁+known offset. Also as mentioned above, the misdetection mitigation system 206 receives the scan timings from the mobile device 214 including scan timestamps for when each image in the verification token is viewed by the camera 216 of the mobile device 214. In one or more implementations, the misdetection mitigation system 206 determines differences between pairs of display timings and scan timings, where the display timing and the scan timing in each pair correspond to the same image (e.g., QR code) in the verification token.

The misdetection mitigation system 206 further determines whether the differences between the display timings and the scan timings satisfy a predetermined threshold at step 324. For example, in one implementation, the misdetection mitigation system 206 determines that the predetermined threshold is satisfied when at least one of the differences between the pairs of display timings and scan timings is less than the predetermined threshold. In other implementations, the misdetection mitigation system 206 determines that the predetermined threshold is satisfied when all of the differences between the pairs of display timings and scan timings are less than the predetermined threshold. In yet further implementations, the misdetection mitigation system 206 determines that the predetermined threshold is satisfied when a predetermined percentage (e.g., at least half) of the differences between the pairs of display timings and scan timings are less than the predetermined threshold.

In one or more implementations, the misdetection mitigation system 206 generates the predetermined threshold in various ways. For example, in one implementation, the misdetection mitigation system 206 generates the predetermined threshold including an amount of time that is less than a combination of the fastest expected QR code scanning time plus the lowest reasonable video lag time. To illustrate, the misdetection mitigation system 206 seeks to generate the predetermined threshold such that a video share application cannot be used to circumvent authentication. For instance, the misdetection mitigation system 206 generates the predetermined threshold to be an amount of time that is less than the time it would take for a first person to share live video of the validation token with a second person who is trying to authenticate a TV in a location outside of an account holder's household.

Additionally, the misdetection mitigation system 206 generates the predetermined threshold including an amount of time that is higher than the amount of time it takes the slowest expected mobile device to scan a QR code. In some implementations, the misdetection mitigation system 206 generates the predetermined threshold in between 210 milliseconds and 290 milliseconds. In a preferred implementation, the misdetection mitigation system 206 generates the predetermined threshold including 300 milliseconds. In additional implementations, the misdetection mitigation system 206 allows for the predetermined threshold to be user-selectable and/or user-adjustable.

Based on the outcome of step 324, the misdetection mitigation system 206 unblocks the unknown display device 222 or continues to block the unknown display device 222. For example, if the determined difference(s) are more than the predetermined threshold (e.g., “No” at step 324), the misdetection mitigation system 206 continues to block the unknown display device 222 from receiving streamed content from the subscription service 208 under the subscriber's account at a step 328.

Alternatively, if the determined difference(s) are less than the predetermined threshold (e.g., “Yes” at step 324), the misdetection mitigation system 206 unblocks the unknown display device 222 at a step 326. In one or more implementations, the misdetection mitigation system 206 unblocks the unknown display device 222 by generating a success message for both the unknown display device 222 and the mobile device 214. Additionally, the misdetection mitigation system 206 transmits a subscription service account verification to the unknown display device 222 that enables transmission of the requested content to the unknown display device 222. In some implementations, the misdetection mitigation system 206 also adds the unknown display device 222 and/or the IP address associated with the unknown display device 222 to the subscriber's subscription service account. In at least one implementation, the misdetection mitigation system 206 adds the unknown display device 222 and/or the IP address associated with the unknown display device 222 to the subscriber's subscription service account for a threshold amount of time (e.g., 30 days, 120 days).

As discussed above, the misdetection mitigation system 206 generates and provides a verification process that proves or disproves that the unknown display device 222 is located in the same household as the known display device 220. In one or more implementations, the misdetection mitigation system 206 generates and provides multiple user interfaces to one or more of the unknown display device 222 and the mobile device 214 in connection with this verification process. As such, FIGS. 4A-40 illustrate example user interfaces generated by the misdetection mitigation system 206 as part of the verification process.

For example, FIG. 4A illustrates a user interface 402 generated by the misdetection mitigation system 206 and transmitted to the subscription system application 224b of the unknown display device 222. To illustrate, in response to determining that the unknown display device 222 is not on the same IP address as a seed display device associated with the subscriber's subscription service account, the misdetection mitigation system 206 generates and provides the user interface 402. In one or more implementations, the misdetection mitigation system 206 generates the user interface 402 including language informing the user that the unknown display device 222 is not verified in association with a valid subscriber's subscription service account. As such, in response to a detected selection of the details option 404, the misdetection mitigation system 206 provides additional information with regard to why the unknown display device 222 is not verified.

In response to a detected selection of the learn more option 406, the misdetection mitigation system 206 initiates the verification process in connection with the unknown display device 222. For example, as shown in FIG. 4B, the misdetection mitigation system 206 can update the user interface 402 to include a replace home option 410 and a troubleshooting option 412, as well as a back button 408 and a sign out option 414. In response to a detected selection of the replace home option 410, the misdetection mitigation system 206 provides options for replacing an existing display device associated with the subscriber's subscription service account with the unknown display device 222. Additionally, the misdetection mitigation system 206 signs the unknown display device 222 out of the current subscription service account or moves back to a previous user interface in response to detected selections of the sign out option 414 or back button 408, respectively.

In response to a detected selection of the troubleshooting option 412, the misdetection mitigation system 206 updates the user interface 402 as shown in FIG. 4C. In one or more embodiments, the misdetection mitigation system 206 updates the user interface 402 including a verification option 420, as well as instructions for the verification process. The misdetection mitigation system 206 also generates the user interface 402 including a help option 416 and the back button 408. In response to a detected selection of the help option 416, the misdetection mitigation system 206 provides additional information associated with the verification process beyond what is already displayed.

In one or more implementations, as discussed above, the misdetection mitigation system 206 verifies the location of the unknown display device 222 based on scan timing from the mobile device 214. Accordingly, in response to detecting the mobile device 214 scan the verification option 420, the misdetection mitigation system 206 provides additional information about the verification process to the mobile device 214. For example, as shown in FIG. 4D, in response to the mobile device 214 scanning the verification option 420 displayed on the unknown display device 222, the misdetection mitigation system 206 directs the mobile device 214 to a web page (e.g., via the web browser 218 on the mobile device 214) specific to the verification process. For instance, the misdetection mitigation system 206 generates a webpage 422a including initial instructions for the user of the mobile device 214 at the beginning of the verification process. In one or more implementations, these instructions include ensuring that the mobile device 214 is on the subscriber's home WiFi network, and allowing access to the camera 216 of the mobile device 214. In at least one implementation, the misdetection mitigation system 206 also synchronizes system clocks of both the unknown display device 222 and the mobile device 214 in response to the mobile device 214 scanning the verification option 420.

In one implementation, and in response to a detected selection of the next button 424, the misdetection mitigation system 206 determines whether the mobile device 214 is using the same IP address as is used by a seed display device associated with the subscription service account. In response to determining that the mobile device 214 is on this IP address, the misdetection mitigation system 206 generates and provides the webpage 422c, as shown in FIG. 4F. Alternatively, in response to determining that the mobile device 214 is not on the correct IP address, the misdetection mitigation system 206 generates and provides the webpage 422b shown in FIG. 4E, including additional instructions for adding the mobile device 214 to the WiFi connection associated with the desired IP address. In response to a detected selection of the next button 424, the misdetection mitigation system 206 then generates and provides the webpage 422c, as shown in FIG. 4F.

In one or more implementations, the misdetection mitigation system 206 generates the webpage 422c including final instructions about scanning a verification token. For example, in at least one implementation, the final instructions include language explaining what the user of the mobile device 214 is about to see on the unknown display device 222. In response to a detected selection of a generate code option 426, the misdetection mitigation system 206 generates a verification token (e.g., as described in connection with the step 314 discussed above with reference to FIG. 3). In at least one implementation, the misdetection mitigation system 206 provides an animated demonstration of a verification token being displayed on a TV within the webpage 422c.

Moreover, in response to a detected selection of the generate code option 426 within the webpage 422c as shown in FIG. 4F, the misdetection mitigation system 206 can provide a webpage 422d on the mobile device 214 as shown in FIG. 4G. For example, the misdetection mitigation system 206 generates and provides the webpage 422d including a camera viewfinder 432 and instructions to point the camera 216 of the mobile device 214 at the unknown display device 222 while the unknown display device 222 displays the verification token. In at least one implementation, the misdetection mitigation system 206 provides the camera access notification 428 in response to determining that the webpage 422d does not have access to the camera 216. The misdetection mitigation system 206 accesses the camera 216 in response to a detected selection of the OK button 430.

Once the misdetection mitigation system 206 has access to the camera 216, the webpage 422d updates to show the image stream from the camera 216 in the camera viewfinder 432, as shown in FIG. 4H. As discussed above, in a preferred embodiment, the misdetection mitigation system 206 generates the verification token including a series of images (e.g., QR codes). As such, the misdetection mitigation system 206 can continually update a status bar 434 on the webpage 422d while the unknown display device 222 (e.g., the subscription system application 224b of the unknown display device 222) generates scan timings associated with each of the images in the verification token. In one example implementation, the misdetection mitigation system 206 updates a border of the camera viewfinder 432 (e.g., from gray to green) to indicate that the camera 216 is correctly pointed at the unknown display device 222.

As shown in FIG. 4I, the misdetection mitigation system 206 generates and transmits a verification token 436 to the unknown display device 222. In one or more implementations, as discussed above, the misdetection mitigation system 206 generates the verification token 436 including instructions for displaying the verification token 436 according to a known offset. As such, the unknown display device 222 displays the verification token 436 by showing each image included in the verification token 436 for an amount of time indicated by the known offset. Additionally, in some implementations, the unknown display device 222 displays the images of the verification token 436 in a loop for a predetermined amount of time (e.g., two minutes). In at least one implementation, the misdetection mitigation system 206 exits the verification process in response to a detected selection of the dismiss option 438.

While the unknown display device 222 displays images of the verification token 436 in a loop, the misdetection mitigation system 206 continually updates the status bar 434 within the webpage 422d on the mobile device 214, as shown in FIGS. 4J, 4K, and 4L. Additionally, in one or more implementations, the misdetection mitigation system 206 updates instructions within the webpage 422d informing the user of the mobile device 214 about the progress of the verification token scan (e.g., “Hold steady for 2 seconds,” “1 more second,” “Just a moment,” etc.). As discussed above, in at least one implementation, the mobile device 214 generates scan timings during the verification token scan including scan timestamps for when each image of the verification token 436 is viewed or perceived by the camera 216 of the mobile device 214.

As shown in FIG. 4M, the misdetection mitigation system 206 generates and provides the webpage 422e via the web browser 218 of the mobile device 214 while determining whether the scan timing relative to the unknown display device 222 displaying the verification token 436 satisfies the predetermined threshold. For example, as discussed above with regard to step 322 and step 324 shown in connection with FIG. 3, the misdetection mitigation system 206 makes this determination by calculating a difference between display timings associated with the unknown display device 222 and scan timings from the unknown display device 222, then determining whether that difference is less than the predetermined threshold.

In response to determining that the predetermined threshold is satisfied, the misdetection mitigation system 206 updates the mobile device 214 with the webpage 422f including a success message, as shown in FIG. 4N. Additionally, as shown in FIG. 4O, the misdetection mitigation system 206 also updates the user interface 402 including the success message. In one or more implementations, the misdetection mitigation system 206 also provides a start watching option 440 as part of the updated user interface 402. In response to a detected selection of the start watching option 440, the misdetection mitigation system 206 enables access to the subscriber's account via the subscription system application 224b by transmitting a subscription service account verification to the unknown display device 222 that enables the unknown display device 222 to access subscription service content—such as a subscription service menu of available content items.

As discussed above, in some implementations, the misdetection mitigation system 206 requests that the mobile device 214 be on the subscription service user's home sub-network (e.g., WiFi connection)—in other words, on the sub-network indicated by the subscriber's subscription service account. In one or more implementations, the misdetection mitigation system 206 considers a mobile device on the subscription service user's home sub-network to be a “trusted” mobile device. It is possible for the mobile device 214 to be on a different sub-network, even though it is located at the subscriber's home (i.e., the mobile device 214 is validly located). In that implementation, the misdetection mitigation system 206 considers the mobile device 214 to be an “untrusted” mobile device.

In one or more implementations, when the mobile device 214 is “untrusted,” the misdetection mitigation system 206 provides additional steps in the verification process that serve to prove the valid location of the mobile device 214. For example, in one or more implementations as shown in FIG. 5, the misdetection mitigation system 206 provides additional verification steps in connection with the known display device 220. In more detail, following the determination that the scan timings relative to the unknown display device 222 displaying the verification token (e.g., the verification token 436) satisfies the predetermined threshold (e.g., following the step 324 “Yes” as shown in FIG. 3), the misdetection mitigation system 206 can determine that the mobile device is untrusted in step 502, as shown in FIG. 5. As mentioned above, in one or more implementations, the misdetection mitigation system 206 determines that the mobile device 214 is untrusted in response to determining that the mobile device 214 is on neither the sub-network associated with the unknown display device 222 nor the sub-network associated with the known display device 220.

In one or more implementations, at step 504, the misdetection mitigation system 206 further generates a list of known display devices associated with the subscription service account. For example, in at least one implementation, the subscription service account is associated with multiple known display devices (e.g., additional TVs located within the subscriber's household). In some examples, the misdetection mitigation system 206 generates the list of known display devices to give the user of the mobile device 214 an option of which display device to use in connection with the additional verification steps shown in connection with FIG. 5. In response to the misdetection mitigation system 206 generating this list, the mobile device 214 (e.g., via the web browser 218) displays the list and additional verification instructions at step 506. In at least one embodiment, the additional verification instructions tell the user of the mobile device 214 to turn on the known display device 220. At step 508, the known display device 220 initializes a subscription system application associated with the subscription service 208 (e.g., the subscription system application 224a).

In response to detecting initialization of the subscription system application 224a, the misdetection mitigation system 206 generates an additional verification token at step 510. For example, in at least one implementation, the misdetection mitigation system 206 generates the additional verification token such that it is similar to the previous verification token 436. To illustrate, the misdetection mitigation system 206 generates the additional verification token including one or more images (e.g., QR codes) and a known offset. In an alternative implementation, rather than generating an additional verification token, the misdetection mitigation system 206 reuses the previously generated verification token 436.

In response to receiving the additional verification token, the known display device 220 (e.g., via the subscription system application 224a) displays the additional verification token according to the known offset associated with the additional verification token in step 512. As discussed above with regard to step 316 in FIG. 3, the known display device 220 displays the additional verification token such that each image in the verification token is displayed for an amount of time corresponding to the known offset. Moreover, at step 514, the mobile device 214 scans the additional verification token via the camera 216. In one or more implementations, as discussed above with regard to step 320 in FIG. 3, the mobile device 214 generates scan timings at step 516.

Additionally, at step 518 and step 520, the misdetection mitigation system 206 determines whether the difference between the display timings and the scan timings satisfy the predetermined threshold. For example, as discussed above with reference to step 322 and step 324 in FIG. 3, the misdetection mitigation system 206 determines that the scan timings associated with the additional verification token relative to the known display device 220 displaying the additional verification token either satisfies the predetermined threshold or fails to satisfy the predetermined threshold.

In response to determining that the predetermined threshold is not satisfied (e.g., “No” at step 520), the misdetection mitigation system 206 assumes that the mobile device 214 is not located in the subscriber's home. In response to this assumption, the misdetection mitigation system 206 further determines that the unknown display device 222 is also not located in the subscriber's home. Accordingly, at step 524, the misdetection mitigation system 206 continues to block the unknown display device 222.

In response to determining that the predetermined threshold is satisfied (e.g., “Yes” at step 520), the misdetection mitigation system 206 further determines that the mobile device 214 and the unknown display device 222 are located in the subscriber's home. Accordingly, at step 522, the misdetection mitigation system 206 unblocks the unknown display device 222 and transmits a subscription service account verification to the unknown display device 222 enabling the unknown display device 222 to display subscription service content, such as a digital content menu. In at least one implementation, the misdetection mitigation system 206 adds the unknown display device 222 to the subscriber's subscription service account. Moreover, in one or more implementations, the misdetection mitigation system 206 further generates success messages for display on one or more of the mobile device 214, the known display device 220, and the unknown display device 222.

In one or more implementations, the misdetection mitigation system 206 generates and provides user interfaces in connection with the untrusted mobile device verification process. FIGS. 6A-6P illustrate user interfaces generated by the misdetection mitigation system 206 for display on the mobile device 214 and the known display device 220 during the untrusted mobile device verification process. In at least one implementation and in response to determining that the mobile device 214 is an untrusted mobile device (e.g., the step 502 in FIG. 5) the misdetection mitigation system 206 generates and provides a webpage 422g via the web browser 218 on the mobile device 214. As shown, the misdetection mitigation system 206 generates the webpage 422g including additional instructions for verifying another display device at the current location.

In one or more implementations, the misdetection mitigation system 206 simultaneously generates and provides the updated user interface 402 on the unknown display device 222, as shown in FIG. 6B. For example, the misdetection mitigation system 206 updates the user interface 402 with instructions for the user of the mobile device 214 to keep the unknown display device 222 turned on until the verification process is finished in connection with the known display device 220. In at least one implementation, the misdetection mitigation system 206 cancels the verification process in response to a detected selection of the cancel option 604 or the sign out button 606.

In response to a detected selection of the next button 602 within the webpage 422g as shown in FIG. 6A, the misdetection mitigation system 206 generates the updated webpage 422h for display via the web browser 218 of the mobile device 214 as shown in FIG. 6C. In one or more implementations, the misdetection mitigation system 206 generates the updated webpage 422h including additional instructions informing the user of the mobile device 214 what to expect during the remainder of the verification process. Additionally, in at least one implementation, the misdetection mitigation system 206 adds identifiers for known display devices associated with the subscriber's subscription service account.

In response to a detected selection of the finish verifying option 608, the misdetection mitigation system 206 again determines whether the mobile device 214 is on the same sub-network (e.g., WiFi connection) as the known display device 220. If the mobile device 214 is on the same sub-network, the misdetection mitigation system 206 unblocks the unknown display device 222 and the verification process ends. If the mobile device 214 is still not on the same sub-network, the misdetection mitigation system 206 generates and provides the webpage 422i with more information about the rest of the verification steps, as shown in FIG. 6D.

In response to a detected selection of the next button 602 from the webpage 422i, the misdetection mitigation system 206 generates and provides the webpage 422j as shown in FIG. 6E. In one or more implementations, the misdetection mitigation system 206 generates the webpage 422j including a selectable list 610 of identifiers for the known display devices associated with the subscriber's subscription service account. In response to a detected selection of one of the items of the selectable list 610 followed by a selection of the next button 602, the misdetection mitigation system 206 assigns the selected identifier as the known display device 220 where the rest of the verification process steps will take place.

For example, as shown in FIG. 6F, the misdetection mitigation system 206 generates and provides the additional webpage 422k with instructions specific to the selected device from the webpage 422j. In at least one implementation, the misdetection mitigation system 206 enables a change in selected device in response to a detected selection of the go back option 612. Moreover, in at least one implementation, the misdetection mitigation system 206 moves forward with the verification steps in response to a detected selection of the next button 602. For example, as shown in FIG. 6G, the misdetection mitigation system 206 generates and provides the webpage 422l including final instructions for receiving and scanning an additional or second verification token on the known display device 220.

In response to detecting an initiation of the subscription system application 224a on the known display device 220, the misdetection mitigation system 206 provides menu options enabling the user of the mobile device 214 to navigate to the additional or second verification token. For example, as shown in FIG. 6H, the misdetection mitigation system 206 provides a verification token menu option 616 via the subscription system application 224a on the known display device 220. In response to a detected selection of the verification token menu option 616, the misdetection mitigation system 206 generates the second verification token 618 and provides the second verification token to the known display device 220, as shown in FIG. 6I. In an alternative implementation, the misdetection mitigation system 206 re-uses the verification token 436 rather than generating a second verification token.

Similar to the scan process described above with reference to FIGS. 4J-4L, in response to a detected selection of the scan code option 614 shown in FIG. 6G, the misdetection mitigation system 206 displays images of the second verification token 618 in a loop according to the known offset for a predetermined amount of time on the known display device 220. Additionally, the misdetection mitigation system 206 simultaneously scans the second verification token 618 with the camera 216 of the mobile device 214. For example, as shown in FIG. 6J, the misdetection mitigation system 206 provides the webpage 422d on the mobile device 214 including the camera viewfinder 432 and the status bar 434. While the user of the mobile device 214 points the camera 216 at the second verification token 618, the misdetection mitigation system 206 updates the webpage 422d as shown in FIGS. 6K, 6L, and 6M.

In response to receiving scan timings from the mobile device 214, as described above, the misdetection mitigation system 206 determines whether the scan timings associated with the second verification token 618 relative to the known display device 220 displaying the second verification token 618 satisfies the predetermined threshold. In at least one implementation, as shown in FIG. 6N, while the misdetection mitigation system 206 makes this determination, the misdetection mitigation system 206 provides the webpage 422e via the web browser 218 on the mobile device 214. In response to determining that the predetermined threshold is satisfied, as shown in FIG. 6O, the misdetection mitigation system 206 updates the web browser 218 with the webpage 422f on the mobile device 214 including a success message. In at least one implementation, as shown in FIG. 6P, the misdetection mitigation system 206 also simultaneously updates the user interface 402 on the unknown display device 222 with a success message and the start watching option 440.

As mentioned above, FIG. 7 is a block diagram of the misdetection mitigation system 206 operating on the subscription server(s) 202. In one or more implementations, the misdetection mitigation system 206 performs many functions in connection with verifying unknown display devices in connection with subscription service accounts. Accordingly, FIG. 7 provides additional detail with regard to these functions. For example, in one implementation as shown in FIG. 7, the misdetection mitigation system 206 includes a location manager 702, a verification token manager 704, and a timing manager 706. In one or more implementations, the misdetection mitigation system 206 further operates in connection with additional elements 210 including subscription service account data 708 and verification token data 710.

In certain implementations, the misdetection mitigation system 206 represents one or more software applications or programs that, when executed by a computing device, cause the computing device to perform one or more tasks. For example, and as will be described in greater detail below, one or more of the components 702-706 of the misdetection mitigation system 206 represents software stored and configured to run on one or more computing devices, such as the subscription server(s) 202. In certain implementations, one or more of the components 702-706 of the misdetection mitigation system 206 shown in FIG. 7 also represent all or portions of one or more special-purpose computers configured to perform one or more tasks.

As mentioned above, and as shown in FIG. 7, implementations of the misdetection mitigation system 206 include the location manager 702. In one or more implementations, the location manager 702 makes determinations regarding locations of mobile devices and display devices based on sub-networks (e.g., WiFi connections) associated with the various devices. For example, in one implementation, the location manager 702 determines that a display device is unknown by comparing an IP address of the display device against IP addresses of known display devices associated with a particular subscription service account. In response to determining that there is a match, the location manager 702 adds the display device as a known display device to the subscription service account. In response to determining that there is no match, the location manager 702 triggers the verification process described herein.

Furthermore, in some implementations, the location manager 702 can verify an unknown display device based on use histories. For example, the location manager 702 accesses use histories associated with an unknown display device and a known display device associated with a subscription service account to identify previous IP addresses associated with both devices. Based on a comparison of the previous IP addresses, the location manager 702 verifies the unknown display device, for example, when there is a match between one or more of the previous IP addresses.

Additionally, in some implementations, the location manager 702 determines whether a mobile device is trusted or untrusted based on a sub-network associated with the mobile device. For example, as discussed above, the location manager 702 identifies a sub-network associated with a mobile device during the verification process, and compares that sub-network to sub-networks associated with the unknown display device (e.g., the unknown display device 222) and one or more known display devices (e.g., the known display device 220) associated with a particular subscription service account. If there is a match between the mobile device and a known display device, the location manager 702 determines that the mobile device is trusted. If there is no match between the mobile device and the known display device, the location manager 702 determines that the mobile device is untrusted.

In some implementations, the misdetection mitigation system 206 utilizes other methods to determine whether a mobile device is trusted. For example, in one implementation, the misdetection mitigation system 206 utilizes use histories to determine that a mobile device is trusted. To illustrate, the misdetection mitigation system 206 utilizes use histories to determine that a mobile device and known display devices associated with a particular subscription service account have historically been on the same IP address. In response to this determination, the misdetection mitigation system 206 identifies the mobile device as a trusted device. In one or more implementations, the misdetection mitigation system 206 generates and trains a machine learning model to receive inputs including historical use data associated with a subscription service account to generate a prediction as to whether a particular mobile device is trusted in connection with that subscription service account.

As mentioned above, and as shown in FIG. 7, implementations of the misdetection mitigation system 206 include the verification token manager 704. In one or more implementations, the verification token manager 704 generates verification tokens as well as offsets. For example, in at least one implementation, the verification token manager 704 generates verification tokens including a series of images. In other implementations, the verification token manager 704 generates verification tokens including single images. In example implementations, the verification token manager 704 generates images of the verification tokens including, but not limited to, QR codes, bar codes, point clouds, encoded images, digital image frames extracted from movies and television shows, and/or other digital images.

Moreover, the verification token manager 704 generates offsets associated with the verification tokens. For example, in some implementations, the verification token manager 704 utilizes a random number generator to generate a new offset for each verification token. In some implementations, the verification token manager 704 generates an offset for each image in a verification token. Alternatively, in at least one implementation, the verification token manager 704 utilizes the same offset for all verification tokens for a predetermined period of time (e.g., one hour), then updates to a new offset.

As mentioned above, and as shown in FIG. 7, implementations of the misdetection mitigation system 206 include the timing manager 706. In one or more implementations, the timing manager 706 determines display timings and scan timings. The timing manager 706 further determines whether scan timing relative to a display device displaying a verification token satisfies a predetermined threshold. For example, in one implementation, the timing manager 706 determines display timings based on a time corresponding to transmission of a verification token to a display device and the known offset associated with that verification token. To illustrate, for a verification token including three images that each display for an amount of time corresponding to the offset, the timing manager 706 determines three display timings: t₀=transmission time; t₁=t₀+offset; and t₂=t₁+offset. Moreover, in some implementations, the timing manager 706 determines scan timings by receiving scan timestamps from a mobile device viewing a verification token, where each scan timestamp corresponds to when the camera of the mobile device viewed or perceived each image in the verification token.

As mentioned above, the timing manager 706 also determines differences between corresponding display timings and scan timings. Next, the timing manager 706 determines whether these differences satisfy a predetermined threshold amount of time. In response to determining that the predetermined threshold is satisfied, the timing manager 706 verifies the display device. In response to determining that the predetermined threshold is not satisfied, the timing manager 706 continues to block the display device. As mentioned above, in a preferred implementation, the timing manager 706 sets the predetermined threshold at 300 milliseconds. In one or more implementations, the timing manager 706 maintains a verification of a display device for a predetermined amount of time (e.g., 90 days). Following this predetermined amount of time, in some implementations, the timing manager 706 re-triggers the verification process in connection with that display device.

As mentioned above, the additional elements 210 include subscription service account data 708. In one or more implementations, subscription service account data 708 includes account information for the accounts maintained by the subscription service 208. For example, in some implementations, account information includes, but is not limited to, subscriber names, subscriber locations, subscriber display devices, and IP address associated with the subscriber display devices. Also as mentioned above, the additional elements 210 include verification token data 710. In one or more implementations, verification token data 710 includes generated verification tokens and/or images for use in verification tokens.

In additional implementations, the misdetection mitigation system 206 further serves in other capacities beyond proving that a display device is legitimately located. For example, in one implementation the misdetection mitigation system 206 uses the same timing gap approach to establish a connection between a mobile device and a TV that are physically co-located but associated with different IP addresses. To illustrate, the misdetection mitigation system 206 establishes a connection between the mobile device and the TV in response to determining that a timing gap between when the TV displays a verification token and when the mobile device scans the verification token satisfies a predetermined threshold.

Moreover, in some implementations, the misdetection mitigation system 206 is used independently to validate devices in contexts beyond IP address mis-matches. For example, in those implementations, the misdetection mitigation system 206 utilizes the same verification token scanning approach to add other types of devices (e.g., tablets, laptops) to a subscription service account-even though the other types of devices are on a known IP address. To illustrate, in one implementation, the misdetection mitigation system 206 generates a verification token for display on a tablet. The misdetection mitigation system 206 further enables the user's mobile device to scan the verification token and provide scan timings. By comparing the verification token's display timings on the table against the scan timings from the user's mobile device, the misdetection mitigation system 206 determines that the tablet should be added as a known device in connection with the user's subscription service account.

As mentioned above, FIG. 8 is a flow diagram of an exemplary computer-implemented method 800 for verifying an unknown display device in association with a subscription service account. In one or more implementations, the steps shown in FIG. 8 are performed by any suitable computer-executable code and/or computing system, including the system(s) illustrated in FIG. 7 (e.g., the misdetection mitigation system 206). In one example, each of the steps shown in FIG. 8 represents an algorithm whose structure includes and/or is represented by multiple sub-steps, examples of which are discussed in greater detail above.

As illustrated in FIG. 8, at step 802 one or more systems described herein detect, at a subscription service server and from a display device, a content request correlated with a subscription service account. For example, as discussed above, the misdetection mitigation system 206 receives a content request that indicates the subscription service account as well as one or more subscription service content items and/or displays (e.g., a subscription service menu).

As further illustrated in FIG. 8, at step 804 one or more systems described herein verify the display device, in response to determining that the display device is not associated with the subscription service account, by receiving scan timing associated with a verification token displayed by the display device at step 806, and determining that the scan timing relative to the display device displaying the verification token satisfies a predetermined threshold at step 808. For example, as discussed above, the misdetection mitigation system 206 determines that the display device is not associated with the subscription service account by determining that the display device's IP address does not match an IP address of at least one known device indicated by the subscription service account. Additionally, as discussed above, the misdetection mitigation system 206 receives the scan timing from a mobile device indicating when the mobile device viewed the verification token. In some implementations, as discussed above, the misdetection mitigation system 206 further determines a display timing based on when the verification token was displayed by the display device and calculates a difference between the scan timing and the display timing. If the difference is less than the predetermined threshold, the misdetection mitigation system 206 verifies the display device.

As further illustrated in FIG. 8, at step 810 one or more systems described herein generate a content request response based on the display device being verified. For example, as discussed above, the misdetection mitigation system 206 generates a content request response including one or more success messages for display on the mobile device and the display device, along with a subscription service account verification that enables the display device to display a subscription service menu.

As such, the misdetection mitigation system 206 presents a streamlined and efficient verification process for verifying a display device in connection with a subscription service account. By utilizing an animated verification token (e.g., a verification token including one or more images that display for an offset amount of time), the misdetection mitigation system 206 can prove that the display device is in a location that corresponds with other known display devices associated with the subscription service account-even when an IP address of the display device is different from IP addresses of the known display devices. The misdetection mitigation system 206 further utilizes the animated verification token to prove that a mobile device is located along with a known display device when the mobile device is also associated with a different IP address. In this way, the misdetection mitigation system 206 can mitigate the issues that arise when a legitimately located display device is misdetected based on its IP address in connection with a subscription service.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
detecting, at a subscription service server and from a display device, a content request correlated with a subscription service account;
in response to determining that the display device is not associated with the subscription service account, verifying the display device by:
receiving scan timing associated with a verification token displayed by the display device; and
determining that the scan timing relative to the display device displaying the verification token satisfies a predetermined threshold; and
generating a content request response based on the display device being verified.

2. The computer-implemented method of claim 1, further comprising determining that the display device is not associated with the subscription service account by:
identifying an internet protocol address of the display device;
identifying an internet protocol address of another device associated with the subscription service account; and
determining that the internet protocol address of the display device fails to match the internet protocol address of the other device associated with the subscription service account.

3. The computer-implemented method of claim 1, wherein verifying the display device further comprises:
generating the verification token for display on the display device; and
causing the display device to display the verification token according to a known offset.

4. The computer-implemented method of claim 3, wherein receiving scan timing associated with the verification token displayed by the display device comprises receiving one or more scan timestamps from a mobile device associated with the subscription service account.

5. The computer-implemented method of claim 4, wherein causing the display device to display the verification token according to the known offset comprises:
synchronizing a time of the display device to a time server associated with the subscription service; and
causing the display device to display the verification token at a display timing based on the known offset and the synchronized time.

6. The computer-implemented method of claim 5, wherein determining that the scan timing relative to the display device displaying the verification token satisfies the predetermined threshold comprises determining that a difference between the display timing and the scan timing is within the predetermined threshold.

7. The computer-implemented method of claim 6, wherein generating the content request response based on the display device being verified comprises:
generating a success message for display on the display device; and
transmitting a subscription service account verification to the display device enabling the display device to display a subscription service menu.

8. A system comprising:
at least one processor; and
physical memory comprising computer-executable instructions that, when executed by the at least one processor, cause the at least one processor to perform acts comprising:
determining that a content request correlated with a subscription service account comes from an unknown display device that is not associated with the subscription service account;
verifying the unknown display device by:
generating an animated verification token for display on the unknown display device;
receiving, from a mobile device associated with the subscription service account, scan timings associated with the animated verification token displayed by the unknown display device; and
determining that the scan timings associated with the animated verification token relative to the unknown display device displaying the animated verification token satisfy a predetermined threshold; and
in response to verifying the unknown display device, generating a content request response for the unknown display device and the mobile device.

9. The system of claim 8, wherein the animated verification token comprises a series of quick response codes, where each quick response code displays according to a known offset.

10. The system of claim 9, wherein receiving the scan timings associated with the animated verification token displayed by the unknown display device comprises receiving a series of scan timestamps, wherein each scan timestamp corresponds to when a quick response code is displayed by the unknown display device as scanned by the mobile device associated with the subscription service account.

11. The system of claim 8, further comprising computer-executable instructions that, when executed by the at least one processor, cause the at least one processor to perform an act comprising determining that the mobile device is a trusted device by:
identifying a sub-network occupied by a known display device associated with the subscription service account; and
determining that the mobile device is on the sub-network occupied by the known display device.

12. The system of claim 8, further comprising computer-executable instructions that, when executed by the at least one processor, cause the at least one processor to perform an act comprising determining that the mobile device is an untrusted device by:
identifying a sub-network occupied by a known display device associated with the subscription service account; and
determining that the mobile device is not on the sub-network occupied by the known display device.

13. The system of claim 12, further comprising computer-executable instructions that, when executed by the at least one processor, cause the at least one processor to perform acts comprising, prior to generating the content request response and in response to determining that the mobile device is an untrusted device:
causing the known display device to display a second verification token; and
receiving, from the mobile device, scan timings associated with the second verification token.

14. The system of claim 13, wherein the second verification token matches the animated verification token.

15. The system of claim 13, further comprising computer-executable instructions that, when executed by the at least one processor, cause the at least one processor to perform an act comprising verifying the unknown display device in response to determining that scan timings associated with the second verification token relative to the known display device displaying the second verification token satisfies the predetermined threshold.

16. The system of claim 15, wherein generating the content request response comprises:
generating a first success message for display on the unknown display device;
generating a second success message for display on the mobile device; and
transmitting a subscription service account verification to the unknown display device enabling the unknown display device to display a subscription service menu.

17. A non-transitory computer-readable medium comprising one or more computer-executable instructions that, when executed by at least one processor of a computing device, cause the computing device to:
detect, at a subscription service server and from a display device, a content request correlated with a subscription service account;
in response to determining that the display device is not associated with the subscription service account, verifying the display device by:
receiving scan timing associated with a verification token displayed by the display device; and
determining that the scan timing relative to the display device displaying the verification token satisfies a predetermined threshold; and
generate a content request response based on the display device being verified.

18. The non-transitory computer-readable medium of claim 17, further comprising computer-executable instructions that, when executed by the at least one processor of the computing device, cause the computing device to generate the verification token comprising a series of quick response codes that display according to a known offset on the display device.

19. The non-transitory computer-readable medium of claim 18, wherein receiving the scan timing associated with the verification token comprises receiving, from a mobile device, a series of scan timestamps wherein each timestamp reflects when a quick response code in the series of quick response codes was displayed by the display device as viewed by the mobile device.

20. The non-transitory computer-readable medium of claim 19, wherein determining that the scan timing relative to the display device displaying the verification token satisfies a predetermined threshold comprises:
determining display timings for when the display device displayed each of the series of quick response codes according to the known offset; and
determining whether differences between corresponding display timings and scan timestamps are within the predetermined threshold.
